(19) United States
(12) Patent Application Publication
(10) Pub. No.: US 2014/0172668 A1
(43) Pub. Date: Jun. 19, 2014

(54) SYSTEM, METHOD AND COMPUTER PROGRAM PRODUCT FOR PERFORMING AN ACTION IN RESPONSE TO AN EVENT

(71) Applicant: salesforce.com, inc., San Francisco, CA (US)

(72) Inventor: Alexander Stephen McClintock, Corona Del Mar, CA (US)

(73) Assignee: salesforce.com, inc., San Francisco, CA (US)

(21) Appl. No.: 14/052,627

(22) Filed: Oct. 11, 2013

Related U.S. Application Data
(60) Provisional application No. 61/738,195, filed on Dec. 17, 2012.

(51) Int. Cl. G06Q 40/00

(52) U.S. Cl. CPC G06Q 40/04
USPC 705/37

(57) ABSTRACT

In accordance with embodiments, there are provided mechanisms and methods for performing an action in response to an event. These mechanisms and methods for performing an action in response to an event can enable enhanced system and user efficiency, improved customer experience and satisfaction, decreased cost, etc.

### CLAIM OF PRIORITY

This application claims the benefit of U.S. Provisional Patent Application No. 61/738,195, entitled “Capital Markets Sales Cloud Solution,” by Alex McClintock, filed Dec. 17, 2012 (Attorney Docket No. 1095PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to identifying events, and more particularly to performing actions in response to those events.

### BACKGROUND

The subject matter discussed in the background section should not be assumed to be prior on merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Many current systems utilize automation to perform one or more actions in response to predetermined criteria. Unfortunately, techniques for implementing these actions have been associated with various limitations. Just by way of example, many current techniques fail to cater to specific types of users (e.g., users associated with the stock market, etc.) when performing actions in response to predefined criteria. Accordingly, it is desirable to provide techniques for performing an action in response to an event.

### BRIEF SUMMARY

In accordance with embodiments, there are provided mechanisms and methods for performing an action in response to an event. These mechanisms and methods for performing an action in response to an event can enable enhanced system and user efficiency, improved customer experience and satisfaction, decreased cost, etc.

In an embodiment and by way of example, a method for performing an action in response to an event is provided. In one embodiment, it is determined that an event has occurred. Additionally, an entity associated with the event is identified in response to the determination. Further, one or more actions associated with the entity are performed.

While one or more implementations and techniques are described with reference to an embodiment in which performing an action in response to an event is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for performing an action in response to an event, in accordance with one embodiment;

FIG. 2 illustrates a method for performing stock market reporting, in accordance with another embodiment;

FIG. 3 illustrates an interface of an exemplary technical analysis software platform, in accordance with another embodiment;

FIG. 4 illustrates an exemplary call list, in accordance with another embodiment;

FIG. 5 illustrates a block diagram of an example of an environment wherein an on-demand database system might be used; and

FIG. 6 illustrates a block diagram of an embodiment of elements of FIG. 5 and various possible interconnections between these elements.

### DETAILED DESCRIPTION

### General Overview

Systems and methods are provided for performing an action in response to an event.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for performing an action in response to an event will be described with reference to example embodiments.

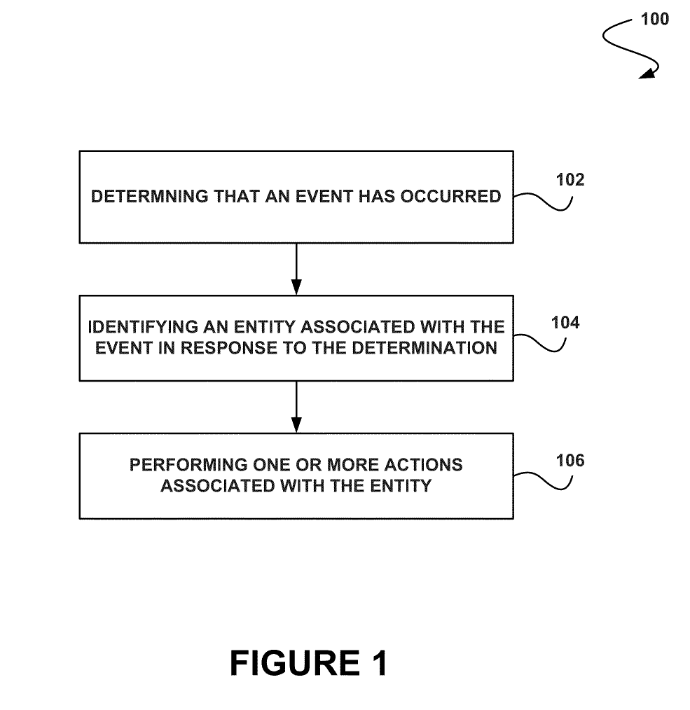

FIG. 1 illustrates a method 100 for performing an action in response to an event, in accordance with one embodiment. As shown in operation 102, it is determined that an event has occurred. In one embodiment, the event may be determined to have occurred when one or more predetermined criteria have been met. For example, the event may be determined to have occurred when one or more identified values meet one or more predetermined criteria.

Additionally, in one embodiment, the determining may include monitoring one or more streams of data. For example, the one or more streams of data may include streaming stock data (e.g., stock process, reports, stock ticker data, etc.). In another example, the one or more streams of data may include streaming news data (e.g., local news data, international news data, financial news data, social news data, etc.).

Further, in one embodiment, the determining may include analyzing the data by comparing data from the one or more data streams against one or more predetermined criteria. For example, it may be determined whether one or more criteria are met by data retrieved from the one or more data streams. In another example, the criteria may include a threshold, and it may be determined whether the threshold has been breached by the data retrieved from the one or more data streams. In another embodiment, the predetermined criteria may include a threshold stock price, a threshold stock volume, a threshold stock increase or decrease, a predetermined news headline (e,g., one or more predetermined keywords), etc.

Further still, in one embodiment, the event may include a stock market event. For example, the event may include a stock price or stock volume reaching a predetermined level, an announcement about a publicly held company, etc. In another embodiment, the event may be determined by a system. For example, the event may be determined by a multi-tenant on-demand database system. In another example, the system may include a financial services system or other system that is associated with one or more financial aspects. In yet another embodiment, the event may be manually entered into the system. For example, a user may manually enter the event into the system when such an event is detected.

Also, in one embodiment, the event may be received automatically by the system. For example, the event may be automatically received by the system utilizing an application programming interface (API) or other means. In another embodiment, the event may be received from a system or entity that is separate from the system that receives the event. For example, a second system separate from a first system may perform monitoring and analysis to identify the event and may send an indication of the event to the first system, where the first system then determines that the event has occurred from its receipt of the indication of the event.

In another embodiment, the event may include an identification of one or more elements associated with the event (e.g., a name of an associated corporation, a stock ticker identification, a product identification, etc.). In yet another embodiment, one or more predetermined characteristics may be associated with the event, and the event may be determined to have occurred when the one or more predetermined characteristics are identified from one or more streams of data.

In addition, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Furthermore, as shown in operation 104, an entity associated with the event is identified in response to the determination. In one embodiment, the entity associated with the event may include an individual, a corporation, an application, etc. For example, the entity may include a client and/or customer of a system, where the entity is involved with the stock market. In another embodiment, the entity may be organized, classified, tiered, or otherwise arranged within a plurality of entities. For example, the entity may be included within a list of entities to be contacted during one or more occurrences.

Further still, in one embodiment, the entity may be manually associated with the event. For example, the entity may be manually added to a list within the system. In another embodiment, the entity may be automatically associated with the event (e.g., according to one or more criteria, etc.). In yet another example, the entity may be associated with the event in response to a request. For example, the entity may be associated with the event in response to a request from the entity that is received by the system (e.g., utilizing a graphical user interface (GUI) provided by the system, etc.).

Also, in one embodiment, the entity may include an object stored within the system. For example, the entity may include an object (e.g., a table, etc.) that stores contact information associated with the entity (e.g., a phone number, an email address, etc.), a name of the entity, one or more identifiers associated with the entity (e.g., usernames, etc.), etc.

Additionally, as shown in operation 106, one or more actions associated with the entity are performed. In one embodiment, performing the one or more actions may include contacting the entity. For example, the entity may be alerted regarding the event. In another embodiment, the entity may be contacted using information associated with the entity. For example, the entity may be contacted using contact information associated with the entity that is stored within an entity object.

Further, in one embodiment, performing the one or more actions may include adding the entity to a call list. For example, a call list may be provided to one or more users on a periodic basis (e.g., daily, hourly, etc.), where the call list indicates entities to be contacted by the one or more users via telephone. In another embodiment, performing the one or more actions may include sending an email to the entity. In yet another embodiment, performing the one or more actions may include posting a message to a social media page (e.g., web page, site, etc.) associated with the entity.

Also, in one embodiment, the one or more actions that are performed may be limited by one or more conditions associated with the entity. For example, the entity object may include one or more restrictions that limit the ways in which the entity is contacted (e.g., only by private email or phone, not by public social media postings, etc.). In another embodiment, performing the one or more actions may include confirming that the entity was contacted regarding the event. For example, a supervisor of a user may be notified to confirm that the user has contacted the entity regarding the event. In another example, if a user has contacted the entity regarding the event, an automatic notification of such contacting may be sent to a supervisor of the user. In this way, entities associated with particular events may be personally notified when such events occur.

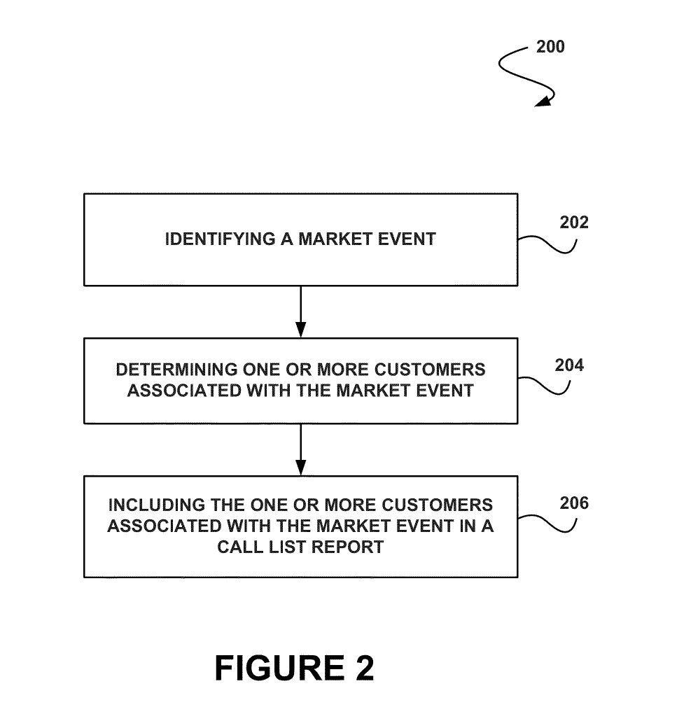

FIG. 2 illustrates an exemplary method 200 for performing stock market reporting, in accordance with another embodiment. As an option, the method 200 may be carried out in the context of the functionality of FIG. 1. Of course, however, the method 200 may be carried out in any desired environment. The aforementioned definitions may apply during the present description.

As shown in operation 202, a market event is identified. In one embodiment, the market event may include an event associated with one or more stock markets (e.g., one or more stocks traded within one or more stock markets, etc.). For example, the market event may be associated with stock activity within one or more stock markets. In another embodiment, the market event may include an event associated with one or more news stories regarding one or more stocks traded within one or more stock markets.

Additionally, in one embodiment, the market event may include an inbound event that is received at a system. For example, the market event may include an inbound market event entry that is automatically received at the system utilizing a web services API within the system. In another example, the market event may include an inbound market event that is manually entered into the system by an administrator (e.g., before a morning call, etc.). In another embodiment, the market event may be a situation where a stock that an institutional sales representative has important customers in or that an equity analyst covers is down 10% in pre-market or has traded at 300% of average daily volume.

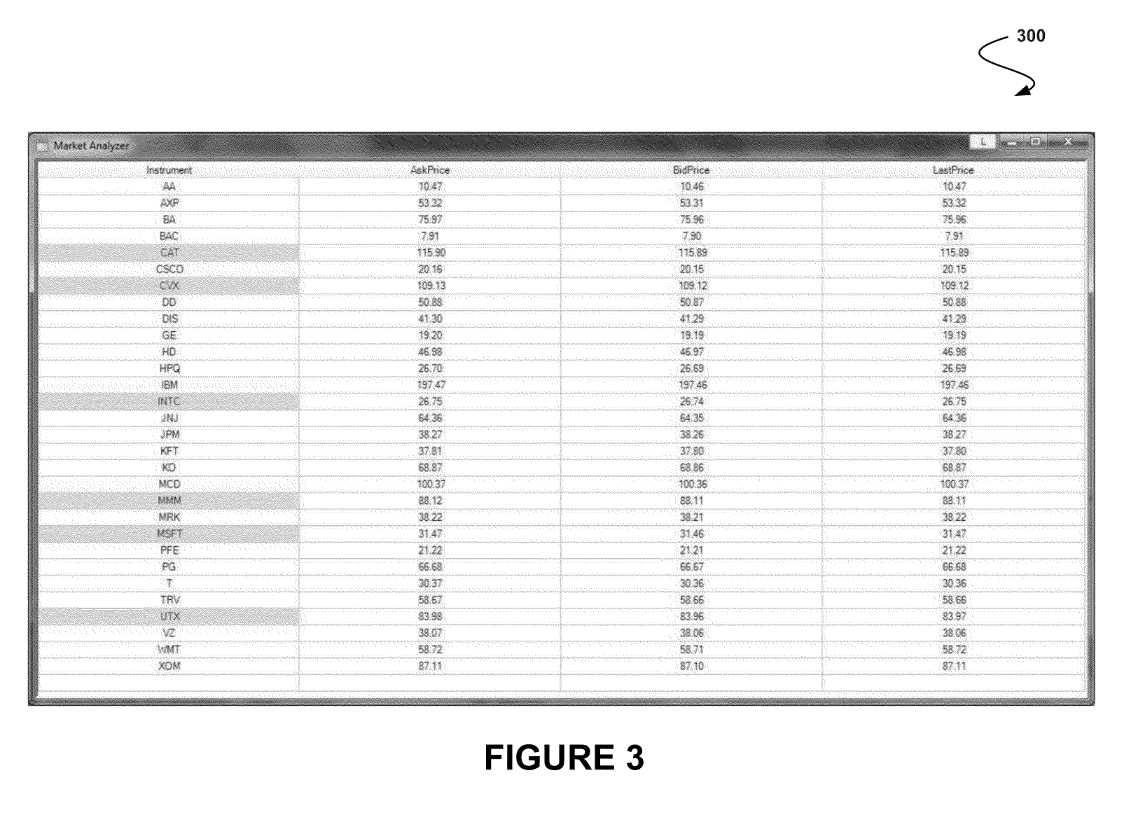

Further, in one embodiment, the market event may be identified through analysis performed within the system. For example, one or more applications within the system may monitor data associated with one or more stocks within one or more stock markets. In another example, one or more applications within the system may analyze the monitored data (e.g., by comparing the monitored data to one or more thresholds, inputting the monitored data into one or more analysis equations, etc.). FIG. 3 illustrates an interface 300 of an exemplary technical analysis software platform that performs a continuous scan of stock data 302 traded within a predetermined stock market. In one embodiment, an automated entry of market events into the system may be generated from a technical analysis platform that may continually calculate if a pre-determined indicator threshold has been breached by comparing the scanned stock data to the threshold. If the indicator threshold is breached, the system may receive a market event, and one or more market event records may be created utilizing a system API.

Further still, as shown in operation 204, one or more customers associated with the market event are determined. In one embodiment, the one or more customers may include one or more customers of the system. In another embodiment, the one or more customers may include customers of a client of the system. In yet another embodiment, each of a plurality of customers may be associated with (e.g., linked with, etc.) one or more predetermined stocks, one or more predetermined corporations, etc. For example, each of the plurality of customers may be represented by a customer object within the system, and an identifier of one or more predetermined stocks (e.g., the stock ticker, etc.) and/or one or more corporations may be linked to each customer object.

Also, in one embodiment, a customer may be automatically associated with a stock when it is identified that the customer purchases the stock. In another embodiment, a customer may be associated with a stock in response to a request by the customer to be associated with the stock (e.g., a request submitted by the customer utilizing a GUI of the system, etc.). In another embodiment, the market event may be associated with a predetermined stock and/or a predetermined corporation, and all customers associated with the predetermined stock and/or corporation (e.g., via their customer object, etc.) may be determined to be associated with the market event.

Additionally, as shown in operation 206, the one or more customers associated with the market event are included in a call list report. In one embodiment, the call list report may include a report that is sent to one or more users that indicates one or more customers who are to be contacted by the one or more users. In another embodiment, the call list report may be sent to one or more users of the system. For example, the call list report may be emailed at a predetermined time of day. In another example, the call list report may be generated on demand. In yet another example, the call list report may be emailed in response to the identification of the market event.

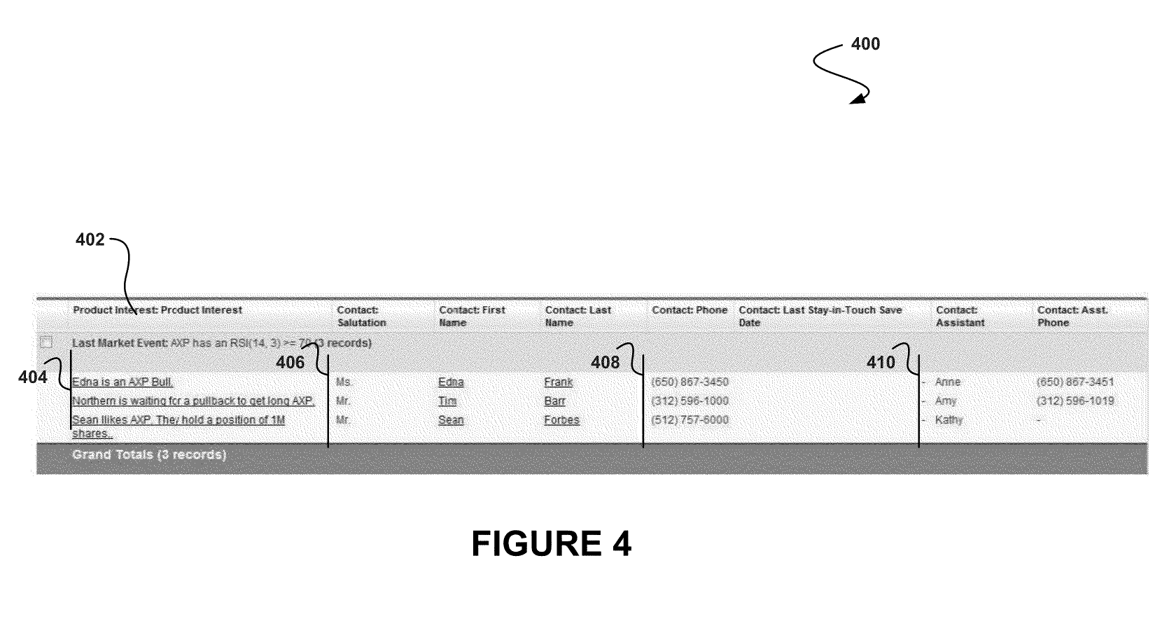

Further, in one embodiment, customers may be ordered within the call list report. For example, customers may be ranked within the call list report according to importance, relevance, significance, etc. FIG. 4 illustrates an exemplary call list 400 including an event description 402 identifying a market event, customer descriptions 404 containing information describing a plurality of customers, customer names 406, customer contact information 408, and contact assistant information 410.

Further still, in one embodiment, standard activity reporting may also allow for monitoring (e.g., by sales management, etc.). For example, activities performed based on the call lists (e.g., calls made to customers by users, etc.) may be identified and reported to management. In this way, managers may confirm that key clients are being called. In another embodiment, more complex reporting may be performed that may compare activities generated against contacts or accounts where market events were generated for securities which the contact or account has an interest in. Customer segmentation criteria may also be incorporated to prioritize sales calls.

Also, in one embodiment, social media may be incorporated to allow for discussion of market events by system users. However, one or more of a customer's security, regulatory and compliance requirements may pose constraints on the user of social media. In another embodiment, the system may generate financial market-related events a scan of one or more social media viewpoints to identify one or more market events and update a table of market events within the system.

Additionally, in one embodiment, for other industries, product updates, news, competitor updates and other relevant new information may be identified as events detected and captured by the system and then written into the a market event table within the system, again generating a call list for the sales representative, or even just providing timely competitive intelligence as it might related to key customer interests.

Further, in one embodiment, a technical analysis and/or automated trading software platform may be used to generate real-time market events. Such a platform and/or analysis may have an event driven capability and may integrate with the system API. In another embodiment, the system may include a service which leverages an existing technical analysis library to provide basic analysis and optimized integration where a customer doesn't have an existing capability.

In this way, the system may promote greater sales rep engagement with the system through the generation of the market event generated call lists. With real-time integration to market data present in the POC, quicker notification of events as generated by the technical analysis platform may promote greater engagement with and adoption of the system by sales representatives of various companies. This solution may target early morning meetings and subsequent call activities that occur on a daily basis within institutional sales teams.

Additionally, an association may be made between financial instruments and contacts interested in the various instruments. The system and methods may then be implemented via a associative/junction object. For example, market events may enter the system from integration with a technical analysis platform which is integrated with a market data feed provider to drive the generation of call lists. The sales representative may use the call lists to call contacts for which there has been a market event as determined by the technical analysis software.

Further, by capturing market events related to securities entered manually or via a system web services API, the system may drive usage (e.g., via call list generation, etc.) providing the basis for increased usage and data capture user adoption (i.e. social media discussion of inbound market event data). Associating securities events with customers via the API on a real-time basis may provide a compelling reason for sales representatives to regularly consult the system as one way to react and stay in front of time-sensitive developments.

Further still, using a few new objects, the system may manage market events by having financial instruments associated with contacts to provide a call list for institutional salespeople. The process of associating financial instruments with corresponding contacts may include migrating data where this association already exists into the system, or manual association by administrators and/or assistants initially and/or sales reps on an ongoing basis.

### System Overview

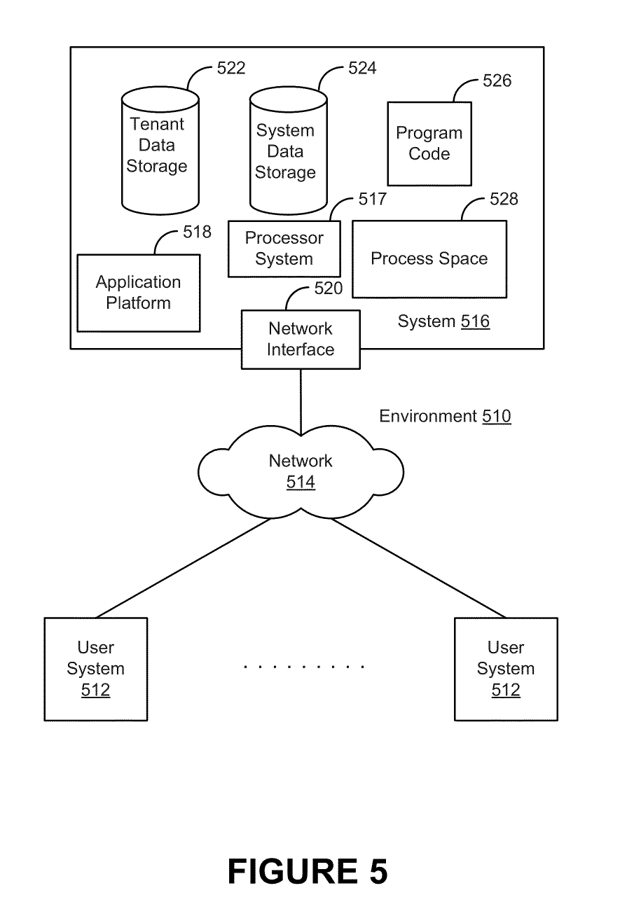

FIG. 5 illustrates a block diagram of an environment 510 wherein an on-demand database system might be used. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

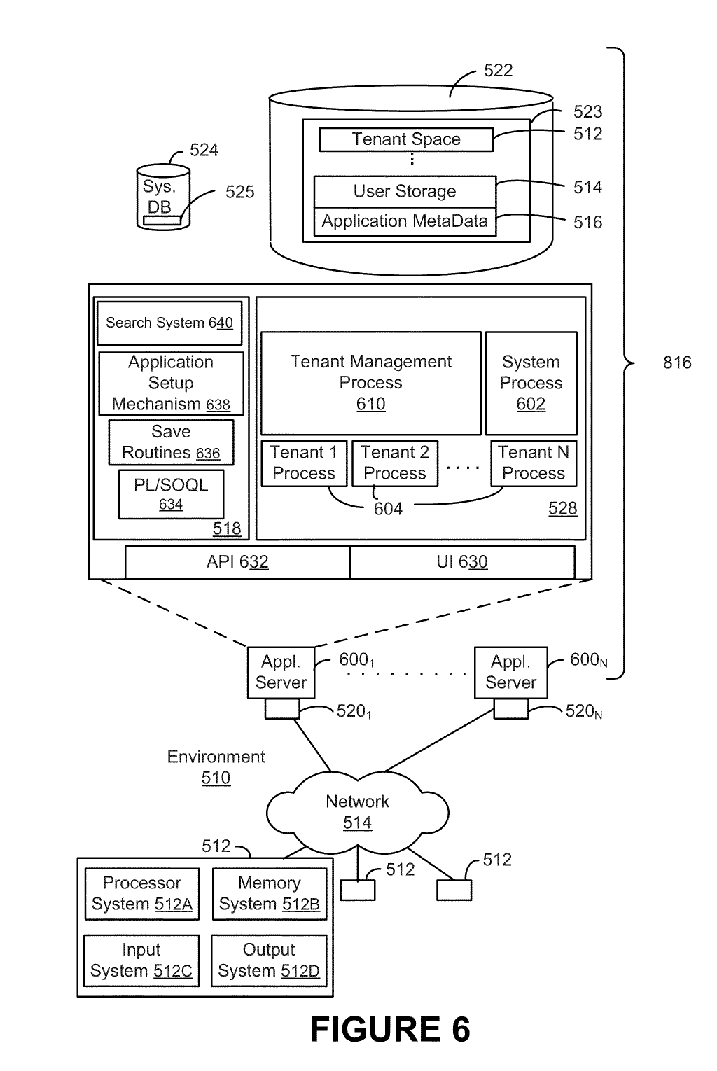

Environment 510 is an environment in which an on-demand database system exists. User system 512 may be any machine or system that is used by a user to access a database user system. For example, any of user systems 512 can be a handheld computing device, a mobile phone, a laptop computer, a work station, and/or a network of computing devices. As illustrated in FIG. 5 (and in more detail in FIG. 6) user systems 512 might interact via a network 514 with an on-demand database system, which is system 516.

An on-demand database system, such as system 516, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database system 516 may include an application platform 518 that enables creation, managing and executing one or more applications developed by the provider of the on-demand database system, users accessing the on-demand database system via user systems 512, or third party application developers accessing the on-demand database system via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Pentium® processor or the like. Similarly, system 516 (and additional instances of an MTS, where more than one is present) and all of their components might be operator configurable using application(s) including computer code to run using a central processing unit such as processor system 517, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 Big-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising:
computer code for determining that an event has occurred;
computer code for identifying an entity associated with the event in response to the determination; and
computer code for performing one or more actions associated with the entity.

2. The computer program product of claim 1, wherein the determining includes monitoring one or more streams of data.

3. The computer program product of claim 2, wherein the one or more streams of data may include streaming stock data.

4. The computer program product of claim 2, wherein the determining includes analyzing the data by comparing data from the one or more data streams against one or more predetermined criteria.

5. The computer program product of claim 4, wherein the criteria include a threshold, and it is determined whether the threshold has been breached by the data retrieved from the one or more data streams.

6. The computer program product of claim 1, wherein the event includes a stock market event.

7. The computer program product of claim 1, wherein the event includes a stock price or stock volume reaching a predetermined level.

8. The computer program product of claim 1, wherein the event is manually entered into a system.

9. The computer program product of claim 1, wherein the event is received automatically by a system.

10. The computer program product of claim 1, wherein the entity associated with the event includes one or more of an individual, a corporation, and an application.

11. The computer program product of claim 1, wherein the entity includes an object stored within a system.

12. The computer program product of claim 1, wherein performing the one or more actions includes contacting the entity.

13. The computer program product of claim 12, wherein the entity is contacted using contact information associated with the entity that is stored within an entity object.

14. The computer program product of claim 1, wherein performing the one or more actions includes adding the entity to a call list.

15. The computer program product of claim 14, wherein a call list is provided to one or more users on a periodic basis, where the call list indicates entities to be contacted by one or more users via telephone.

16. The computer program product of claim 1, wherein performing the one or more actions includes sending an email to the entity.

17. The computer program product of claim 1, wherein performing the one or more actions includes posting a message to a social media page associated with the entity.

18. The computer program product of claim 1, wherein performing the one or more actions may include confirming that the entity was contacted regarding the event.

19. A method, comprising:
determining that an event has occurred;
identifying an entity associated with the event in response to the determination; and
performing one or more actions associated with the entity.

20. An apparatus, comprising:
a processor for:
determining that an event has occurred;
identifying an entity associated with the event in response to the determination; and
performing one or more actions associated with the entity.

21. A method for transmitting code for use in a multi-tenant database system on a transmission medium, the method comprising:
transmitting code for determining that an event has occurred;
transmitting code for identifying an entity associated with the event in response to the determination; and
transmitting code for performing one or more actions associated with the entity.
